(19) United States
(12) Patent Application Publication
(10) Pub. No.: US 2010/0307531 A1
(43) Pub. Date: Dec. 9, 2010

(54) System And Method For Cleaning A Two-Wheeled Vehicle

(76) Inventors: Uriel Aharonov, Aravot Hayarden (IL); Yaron Aharonov, Ra'anana (IL)

Correspondence Address: The Law Office of Michael E. Kondoudis, 888 16th Street, N.W., Suite 800, Washington, DC, 20006, US

(21) Appl. No.: 12/745,618

(22) PCT Filed: Dec. 7, 2008
(86) PCT No.: PCT/IL08/01590

§ 371 Date: Jun. 1, 2010

(30) Foreign Application Priority Data
Dec. 6, 2007 (IL) 187952

(51) Int. Cl. B08B 3/00

(52) U.S. Cl. 134/6; 134/123; 134/34; 134/26

(57) ABSTRACT

A system and method for cleaning a two-wheeled vehicle, such as a bicycle (100). The bicycle's transmission system is activated, for example, by spinning the rear wheel (108). Then, degreaser from the degreasing solution source (62) is sprayed via some or all of the nozzles (28,29) onto the corresponding parts of the bicycle. At this time, those brushes (24) that rotate are rotated. The brushes (24) approach the bicycle to the appropriate distance where the hairs can be in touch with the bicycle to brush away and clean the dirt mechanically. After waiting for the degreaser product (62) to make its effect, cleaning product from the cleaning product source is sprayed via the nozzles (28,29) onto the corresponding parts of the bicycle. When brush rotation is stopped, air from the pressurized air source (64) is blown via the nozzles (28,29) onto the corresponding parts of the bicycle to dry them.

### FIELD OF THE INVENTION

The present invention relates to a system and method for cleaning a two-wheeled vehicle, and in particular for cleaning a bicycle.

### BACKGROUND OF THE INVENTION

Bicycles are a popular sight almost anywhere in the world and serve both as a transportation and recreation mean. First introduced in the 19th century, they now number about one billion worldwide. For many people, the bicycle is their principle means of transportation.

Bicycles today come in a variety of shapes and forms and can be categorized in different ways: e.g. by function, by number of riders, by general construction, by gearing or by means of propulsion. The more common types include utility bicycles (for practical transportation), mountain bicycles (for off-road tracks), racing bicycles (for road cycling), touring bicycles (for carrying heavy loads), hybrid bicycles (for general-purpose utility on paved and unpaved roads), cruiser bicycles (comfortable, single-speed bikes with heavy steel frames), and BMX bicycles (designed for acrobatic racing and free-styling).

A bicycle is typically composed from the following components:
Frame: top tube, down tube, seat tube, seat stay, chain stay;
Two wheels, each comprising spokes, a hub, rim, cover and valve;
Front set: handlebar grip, head tube, shock absorber, front breaks, fork;
Seat set: seat, seat post;
Transmission: rear derailleur, front derailleur, cassette, drive chain, gears; and
Pedal, crank arm and rear breaks.

Like every transportation tool, bicycles also benefit from regular cleaning and maintenance. Cleaning a bicycle involves mainly cleaning the frame, wheels and transmission system from any dirt, dust, mud, grease and the like.

While cleaning the frame, seat and other visible and accessible parts can be fairly straight forward using a combination of cloth and/or brushes with water and a cleaning product, cleaning the transmission can be very tricky since many parts of it are not directly accessible.

There is thus a need to provide an automatic cleaning mechanism that can clean a bicycle entirely, including the transmission system.

### SUMMARY OF THE INVENTION

It is therefore an object of the present invention to provide a system and method for cleaning a bicycle.

It is a further object of the present invention to provide a system and method for automatically cleaning a bicycle.

It is yet a further object of the present invention to provide a system and method for automatically cleaning the transmission system of a bicycle.

In one aspect the present invention thus relates to a bicycle cleaning system, comprising:

(i) one or more spray nozzles wherein at least one spray nozzle is adapted to dispense a cleaning product; and

(ii) a mechanism for reaching all the components of the bicycle's transmission system such that they can be sprayed by said one or more spray nozzles.

In one embodiment of the present invention, one or more brushes are used in order to clean the bicycle including the bicycle transmission system.

In another embodiment of the present invention, the mechanism for reaching all the components of the bicycle's transmission system spins the bicycle's rear wheel.

In yet another embodiment of the present invention, mechanism for reaching all the components of the bicycle's transmission system spins the bicycle's rear wheel counter-clockwise.

In a further embodiment of the present invention, one spray nozzle dispenses a degreaser product.

In yet another embodiment of the present invention, the bicycle cleaning system is adapted for lubrication of the bicycle's transmission system by first dispensing hot and dry air and then dispensing a lubricating product.

In yet a further embodiment of the present invention, one spray nozzle dispenses hot vapor.

In yet another embodiment of the present invention, the cleaning product is a fluid.

In yet a further embodiment of the present invention, the cleaning fluid comprises water and soap.

In yet another embodiment of the present invention, one or more brushes are rotating brushes.

In another aspect, the present invention relates to a method for cleaning a bicycle comprising the steps of:

(i) dispensing a cleaning product through at least one spray nozzle; and

(ii) applying a mechanism for reaching all the components of the bicycle's transmission system such that they can be sprayed by said one or more spray nozzles.

The present invention is particularly suited for the cleaning of a bicycle, however, it should be understood that it may be adapted and used to clean other two-wheeled vehicles, for example, motorcycles, motor-scooters, motocross bikes, and the like. For convenience and consistency, the invention will therefore be referred to as a bicycle cleaning system and method.

### BRIEF DESCRIPTION OF THE DRAWINGS

FIG. 1 is a side view of the inside of an embodiment of a bicycle cleaning system according to the present invention, with a bicycle therein.

FIG. 2 is a rear view of the system of FIG. 1, along line A-A.

FIG. 3 is a rear view of the system of FIG. 1, along line B-B illustrating the cleaning of the bicycle chain.

FIG. 4 is a rear view of the system of FIG. 1, along line C-C.

FIG. 5 is rear view of another embodiment of the bicycle cleaning system.

FIG. 6 is a side view of the rear wheel of a bicycle and showing modified cleaning brushes.

FIG. 7 is a side view of an embodiment of a bicycle cleaning system along with an automated payment and activation unit according to the present invention, with a bicycle therein

FIG. 8 is a rear view of the inside of an embodiment of a bicycle cleaning system according to the present invention, with a bicycle therein

FIG. 9 is a close view of the pulley and cassette cleaning.

FIG. 10 is a schematic view of the bicycle cleaning system of the invention.

### DETAILED DESCRIPTION OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

Although the following description will relate to the system and method of the present invention for cleaning a mountain bicycle, it should be understood that it may be adapted and used to clean regular bicycles as well as other two-wheeled vehicles, for example, motorcycles, motor-scooters and the like. Regardless, for convenience and consistency, the description herein will relate to the invention's use for cleaning a mountain bicycle. Thus the term “bicycle” as referred herein should be interpreted to mean any two-wheeled vehicle including but not limited to any form of bicycle or motorcycle.

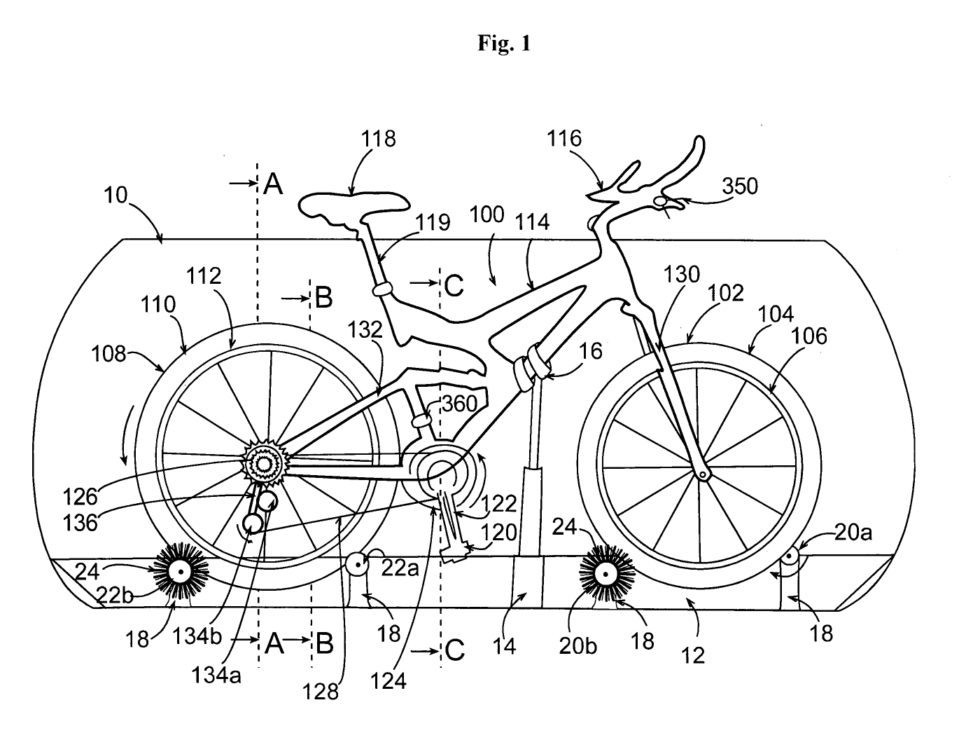

Referring to FIG. 1, there is shown an embodiment of a system for cleaning a bicycle 100. The bicycle 100 comprises standard components including a front wheel 102 having a front tire 104 and front wheel rim 106; a rear wheel 108 having a rear tire 110 and rear wheel rim 112; a frame 114 with handle bars 116 and a seat 118 with a seat post 119 attached to the frame 114; pedals 120 with pedal crank arms 122; front gear wheels or sprockets 124; a rear cassette (frequently also called rear gear wheels; freewheels; or sprockets) 126; brushes 24; a chain 128; a front fork 130; a rear fork 132; upper and lower derailleur pulley wheels 134a and 134b; a front derailleur 360 and a rear derailleur 136.

The system comprises a two-winged shell 10 with a support bottom 12 thereby enclosing all or most of the bicycle 100, with only the seat 118 and handle bars 116 protruding therefrom. Typically, the two-winged shell 10 encloses the entire bicycle 100, including the seat 118 and handle bars 116. Supported at the bottom 12 of the system are: a bicycle support stand 14 with a clamp 16; four stanchions 18 which support four rollers—namely: a front driving roller 20a adapted to spin the front wheel 104; a front cleaning roller 20b adapted to clean the front wheel 102; a rear driving roller 22a adapted to spin the rear wheel 108; and a cleaning roller 22b adapted to clean the rear wheel. During cleaning, the bicycle 100 rests on all four of the rollers 20a, 20b, 22a and 22b, which are appropriately spaced apart for that purpose.

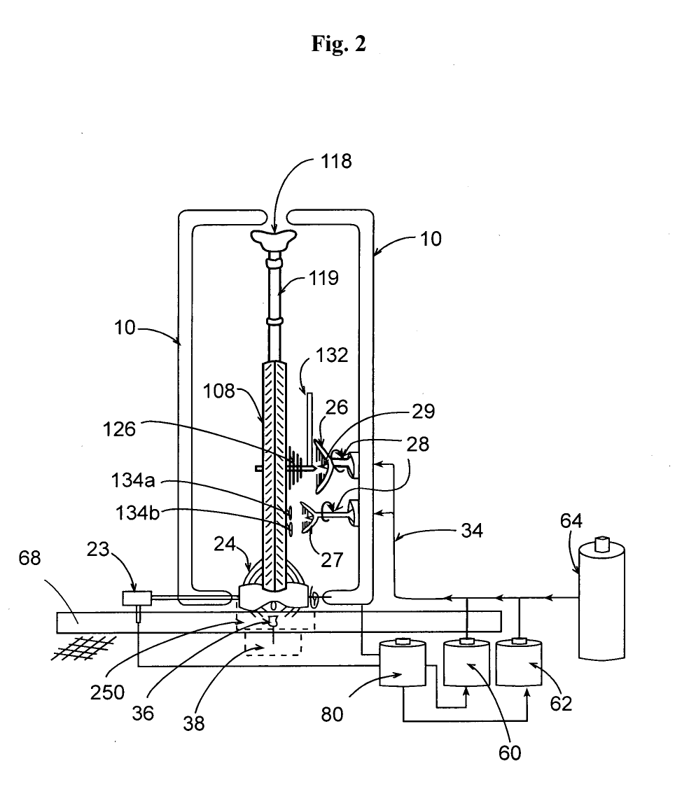

The front and rear driving rollers 20a and 22a have associated therewith motors 23 (one seen in FIG. 2) to rotate them so as to spin the front and rear bicycle wheels 102 and 108. In accordance with other embodiments, the motors 23 are located between the two-winged shell 10; located underground; or instead of motors, the rollers 20a and 22a are rotated via air pressure, as explained below.

Although the rear wheel 108 can be spun in either direction, it is believed preferable to spin it opposite its normal direction of travel while riding, i.e. “backwards” or counter-clockwise, as shown in FIG. 1, as spinning in this direction typically causes the rear wheel 108 to spin. Thus, the rear roller 22a is spun in a clockwise direction, as indicated in FIG. 1. Also, for efficient cleaning, it is believed preferable to have the rear cleaning roller 22b be spun in a direction counter to the spin direction of the rear wheel 108.

The front wheel 102 can be spun in either direction as well, for example, counter-clockwise as shown in FIG. 1 by the front driving roller 20a in the clockwise direction. For the same reason of efficiency of cleaning, the front cleaning roller 22b is shown as being spun in a direction counter to the spin direction of the front wheel 108.

The front and rear cleaning roller 20b and 22b, respectively, have cleaning elements, which in the embodiment shown is constituted by generally U-shaped brushes 24 attached thereto to clean the wheels' tires 104 and 110 and rims 106 and 112.

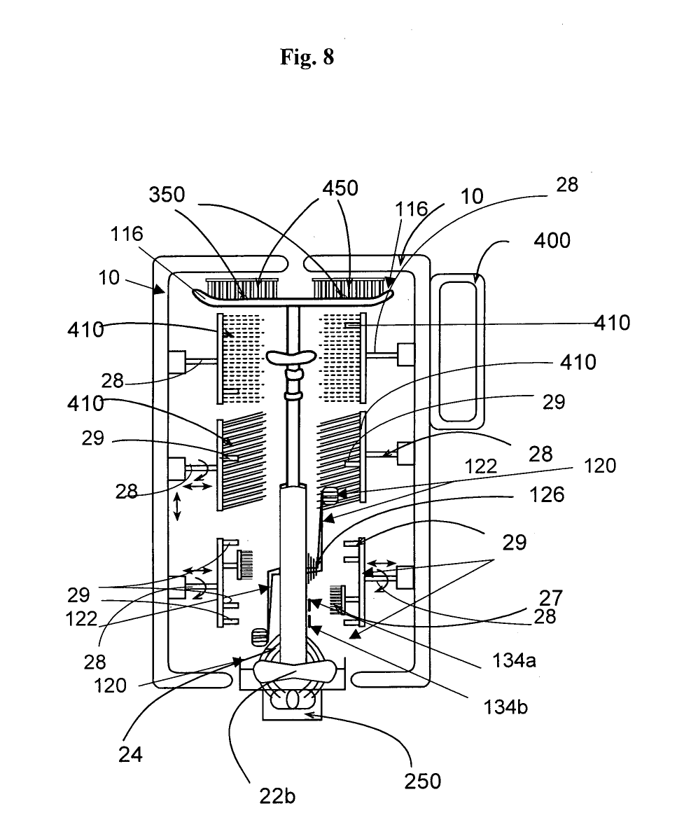

In accordance with other embodiments (not shown), the cleaning elements are constituted by brushes 24 of other geometries, or other methodologies, for example, one or more relatively high pressure spray nozzles; the size, length and material of the brushes 24 and the brushes' 24 hair can vary; the brushes 24 may also spray a cleaning product; the brushes 24 may spray high-pressure air; the brushes 24 may rotate on any angle; or the brushes 24 may travel along a guided rail (illustrated in FIG. 8). Typically, the high-pressure air nozzles dispense air (or any other gas) with a pressure of about 8 to 10 bars.

FIG. 2 shows a view of the cleaning system of the invention along line A-A of FIG. 1 whereby additional cleaning brushes are seen, for example a V- or U-shaped rear sprocket cleaning brush 26 and a V- or U-shaped upper derailleur pulley wheel cleaning brush 27. The system typically also comprises a lower derailleur pulley wheel cleaning brush (not visible). The brushes 26 and 27 are each attached to hollow cylindrical rods 28, which are fixed to one wing of the shell 10, which typically comprises a generally flat and vertical portion for convenient mounting of mounting mechanisms and, respectively. At the free end of the hollow cylindrical rods 28 are spray nozzles 29. A hose 34 is connected to the other end of the hollow cylindrical rods 28 for supplying cleaning products, as will be described below. The spray nozzles 29 can be of any type available in the industry such as a venture nozzle (comprising a convergent inlet section and a divergent outlet section) or a coaxial nozzle.

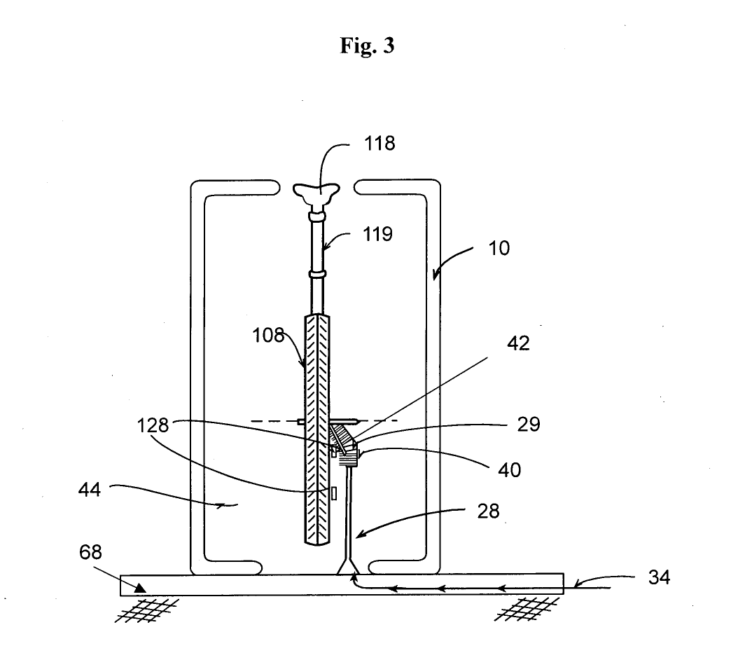

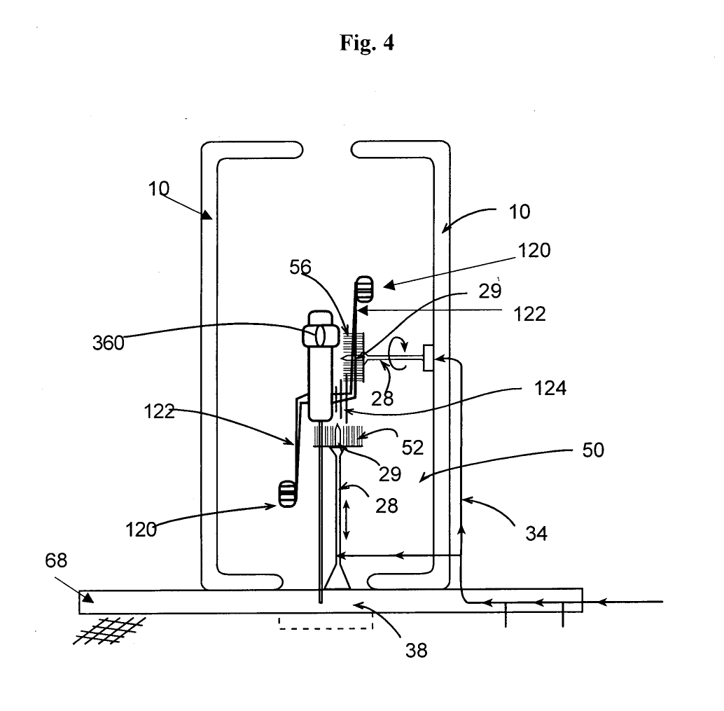

In accordance with particular embodiments, to aid in positioning any or all of the gear/sprocket and chain cleaning brushes 26, 27, 42 (shown in FIG. 3), 52 and 56 (both shown in FIG. 4), the hollow cylindrical rods 28 can be telescopic and/or be extended via a spring activation (not shown) when the system is activated, so that the brushes contact the gears/sprockets 124, 126, 134a and 134b and chain 128 for proper cleaning.

The bicycle 100 is disposed on a platform or pallet 68 that supports the stanchions 18 and is held by an arm 70 attached to the pallet 68, which is adapted to clamp onto the seat post 119.

The system further comprises a cleaning product source 60 container, a degreasing solution source 62 container, a pressurized drying air source 64 and an oil (lubricator) container 80.

Underneath the support bottom 12 is a drain tube 36 leading to a reservoir 38, for collecting cleaning fluid, etc, as will be discussed in more detail below. Optionally, a filter can be used to filter cleaning and/or degreasing solution collected in the reservoir 38.

FIG. 3 shows a chain cleaning mechanism 40 of the system which is generally similar to the sprocket cleaners described above, however adapted for cleaning the bicycle chain 128 in that it comprises a chain cleaning brush 42 designed to surround or virtually surround the chain. The chain cleaning brush 42 is held by a hollow cylindrical rod, such as the rod 28, to which the hose 34 leads in order to supply cleaning solution, etc., to the chain cleaning mechanism 40. Alternatively, the chain cleaning brush 42 is held by a stanchion (not shown).

Best seen in FIG. 3 there is a space 44 inside the shell 10 where a person can stand in order to arrange the bicycle 100 as required. Alternatively, according to other embodiments described below, the bicycle 100 can be arranged from outside the area of the shell 10 and slid within the shell, for example, on a platform or pallet (discussed below).

In accordance with certain embodiments, the chain cleaning brush 42 is constituted by one or more rotating brushes (not shown) or by a brush that loosely clamps down on the chain 128.

FIG. 4 shows a front sprocket cleaning device 50 of the system comprising a brush 52 and a hollow cylinder 28 (alternatively, a stanchion), the brush 52 being located below the front sprockets or front crank 124 to provide proper access thereto. To provide cleaning product (or solution) and air drying, the front sprocket cleaning device 50 further comprises a long strand brush 56 with a nozzle such as the nozzle 29. The long strand brush 56 is adapted for cleaning the front derailleur 360.

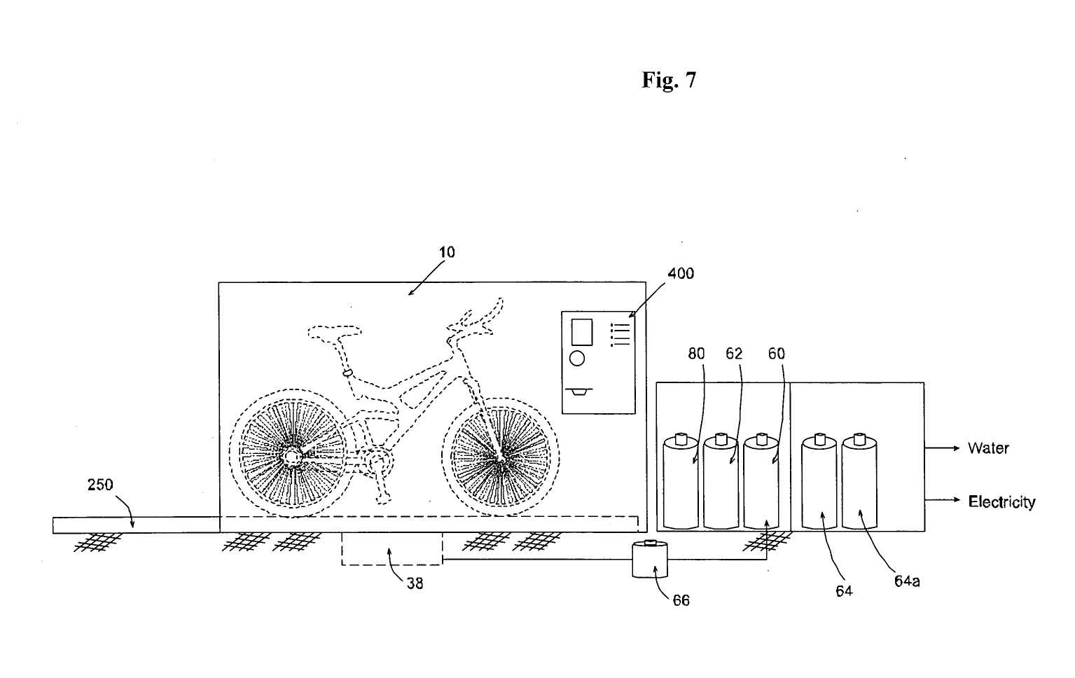

Reverting to FIG. 2, the system further comprises a cleaning and drying system comprising a cleaning product source 60, a degreasing solution source 62 and a pressurized drying air source 64. The system further comprises mechanisms for delivering the cleaning and degreasing products/solutions, for example, pumps (not shown) and delivering air, for example, a compressor or pressurized tank (see FIG. 7). According to certain embodiments, the cleaning product and/or degreaser is propelled by air pressure.

The cleaning product contained in the cleaning product source 60 can be a typical fluid solution such as water and soap. Alternatively, other fluid, gas or solid materials can be used to clean the bicycle 100. For example, small nylon, rubber, sponge corpuscles (or any other equivalent soft material) can be sprayed in high pressure in order to clean the bicycle 100.

In accordance with other embodiments, the drying air can be heated and the cleaning and/or degreasing solutions can be sprayed from nozzles separately from the brushes.

The pressurized air can be used to rotate any or all of the rotatable brushes 24, 26, 27, 42, and 52 (as well as the driving rollers 20a and 20b), else, according to other embodiments, some or all of them are rotated by other means (e.g. a small motor, such as the motor 23 seen in FIG. 2).

In accordance with particular embodiments, the system comprises a filter 66 to filter cleaning and/or degreasing solution collected in the reservoir 38. Filtered solutions can then recycled for use in the system or off-site recycling.

In accordance with particular embodiments, the system further comprises a lubrication system (see FIG. 7) comprising an oil container 80 to provide lubrication or oil to the gears/sprockets/chain, for example, via a plurality of oil droppers (not shown), mutatis mutandis. In such case, lubrication would preferably commence after the appropriate parts have been dried.

It should be understood that although certain cleaning brushes have been described as fixed via mechanisms attached to the shell 10 or by stanchions on the bottom of the system, for design convenience, some or all of the brushes can be fixed either at the shell 10 or bottom thereof.

Although the system can be designed to have the rollers 20a, 20b, 22a and 22b spaced apart to suit a reasonably wide variety of bicycles, in accordance with certain embodiments, the position of the rollers are adjustable, for example, slidable and fixable along a track (not shown), to allow use of bicycles of greatly different sizes.

In this regard, the bicycle support stand 14 is preferably adjustable, e.g. telescoping, in order to suit different types/sizes of bicycles.

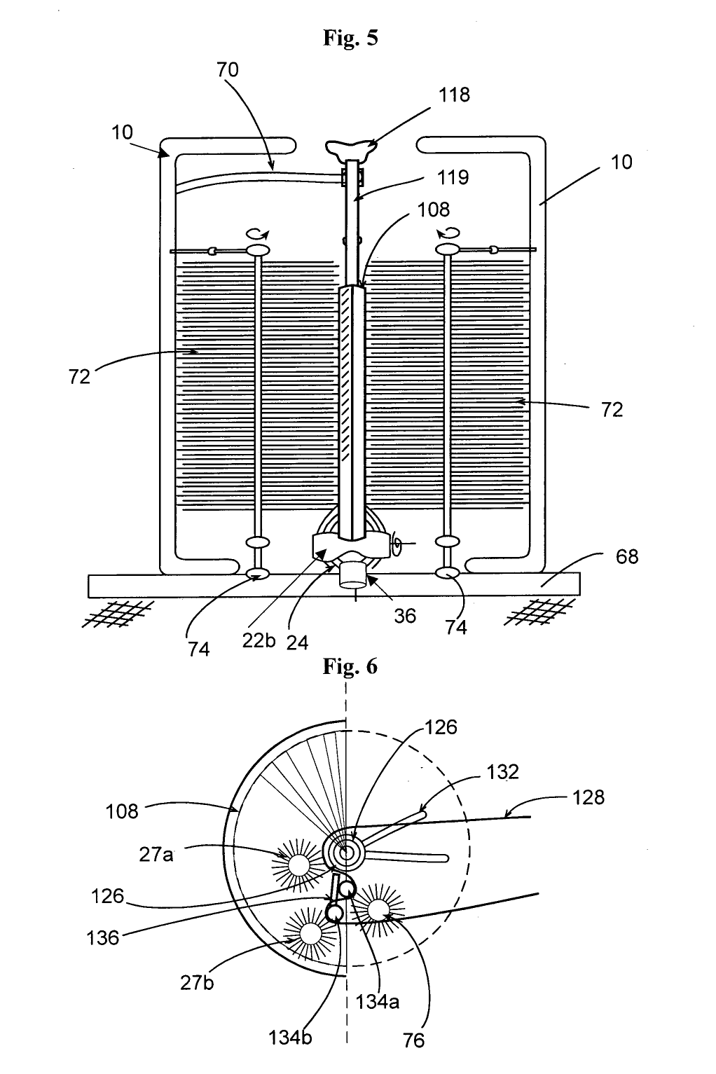

FIG. 5 illustrates another embodiment of the bicycle cleaning system configured to allow positioning of the bicycle 100 from outside the shell 10 prior to moving it, preferably automatically, into/between the shell 10 for cleaning. The bicycle 100 is disposed on a platform or pallet 68 that supports the stanchions 18 and is held by an arm 70 attached to the pallet 68, which is adapted to clamp onto the seat post 119.

According to certain embodiments, the system further comprises a sub-system to provide a general cleaning of the bicycle, in addition to the non-moving components (e.g. the bicycle frame 114). An example of such a general cleaning system is shown in FIG. 5 and comprises a pair of relatively large vertically oriented brushes 72. The vertically oriented brushes 72 are arranged along brush holding tracks 74 to facilitate movement back and forth along the bicycle 100 and typically are adapted to spray cleaning product (typically a solution, though gas and solid cleaning products can also be used with the invention). In accordance with certain embodiments, the brush holding tracks 74 can be moved inwardly and outwardly to optimize their location for cleaning. According to further embodiments, there are two sets of vertically oriented brushes 72 on each side of the bicycle 100, a set in front of the pedals 120 and a set behind, to avoid interference therewith.

FIG. 6 is a side view of the rear wheel 108 of the bicycle 100 showing modified brushes 27a, 27b and 76, for cleaning its rear sprocket 126, pulley gears 134a and 134b, rear derailleur 136 as well as the chain 128. These brushes 27a, 27b and 76 can comprise nozzles such as nozzles 29, which protrude from the center of the brushes 27a, 27b and 76, however oriented to compensate for the different angle of the brushes 27a, 27b and 76 and ensure proper spraying on and drying of the corresponding bicycle 100 components.

According to particular embodiments, the system further comprises a front panel and a rear panel (not shown) to mitigate the errant cleaning spray.

According to other embodiments, the system is adapted to support the bicycle 100 by its two-winged shell 10 and therefore does not require the bicycle support stand 14.

In another embodiment of the present invention, in addition to cleaning the bicycle 100 additional maintenance treatments are performed, such as: spraying the front and back tires 104, 110 with a product to protect the rubber from cracking; the frame 114 can sprayed with a polishing material that the user (or any other person) can then wipe with an offered cloth; or the system can offer the user (or any other person) a cloth soaked in a polishing material so that the frame 114 can be adequately wiped.

Reference is now made to FIG. 7 illustrating a side view of an embodiment of a bicycle cleaning system along with an automated payment and activation unit 400 according to the present invention. The bicycle 100 is placed on a track 250 and is then moved manually or automatically inside the two-winged shell 10. An automated payment and activation unit 400 can be coupled to the cleaning system, for example, for selecting an appropriate cleaning program. Optionally, the user may also pay for the cleaning at the payment and activation unit 400 via available payment options such as cash, credit cards, coupons, tickets, tokens and the like.

Recycling natural resources such as water is an important priority nowadays. Accordingly, in one embodiment, the cleaning system of the invention comprises a reservoir 38 underneath the support bottom 12. Cleaning fluid and degreasing fluid are collected through one a drain tube 36 leading to the reservoir 38. From the reservoir 38, the fluid can be filtered by an adequate filter 66 and then put back in the cleaning product source 60 container or the degreasing solution source 62 container. When not recycled, the used cleaning and degreasing fluid is drained.

In yet another embodiment, the cleaning system further comprises an air compressor 64a to compress the air inside the pressurized drying air source 64.

In yet another embodiment, the cleaning system further comprises an oil container 80 for lubricating the transmission system.

The term “transmission system” as referred herein should be interpreted to cover the rear derailleur 136, front derailleur 360, cassette 126, drive chain 128, gears sprockets or crank 124, the front gear transmission handle 350, and pulley wheels 134a and 134b.

In yet another embodiment, the cleaning system further comprises a container with a protective tire coating that can be sprayed unto the front and back tires 104, 110 in order to prolong the life of the tires.

Reference is now made to FIG. 8 illustrating a rear view of the inside of an embodiment of a bicycle cleaning system according to the present invention. The rear side of the bicycle 100 is shown placed on a track 250. The two-winged shell 10 is adapted to move closer and away from the bicycle 100 as required for cleaning operations. On the upper side of the shell 10 are shown two gear transmission handle brushes 450 adapted for cleaning the gear transmission handle 350 and handle bars 116. In the embodiment shown, the gear transmission handle brushes 450 are adapted for both spraying a cleaning product and brushing. It is however, possible to include separate adapted spray nozzles (not shown). The handle brushes 450 can rotate along the handle bars 116 and also move horizontally closer and away from each other.

Shown below are a pair of frame brushes 410 and frame spray nozzles 29 adapted for cleaning the frame 114 of the bicycle 100. The frame brushes 410 are adapted to move up and down (as shown with the dotted lines) and also rotate if necessary. The frame brushes 410 can also move horizontally to get closer or further away from the frame 114 as required for the cleaning operation.

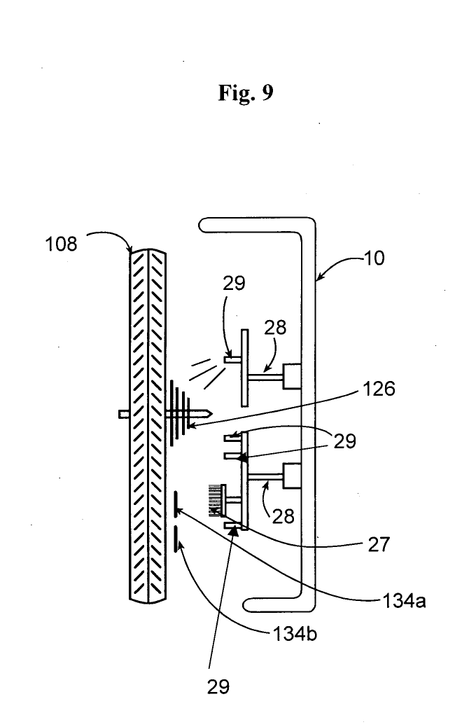

Reference is now made to FIG. 9 showing a close view of the cleaning of the pulley wheels 134a, 134b and sprockets 126 using spray nozzles 29 and adapted cleaning brushes 26 and 27. The cleaning brushes 26 and 27 can move up and down and get closer and away from the bicycle 100 as required for the cleaning operation.

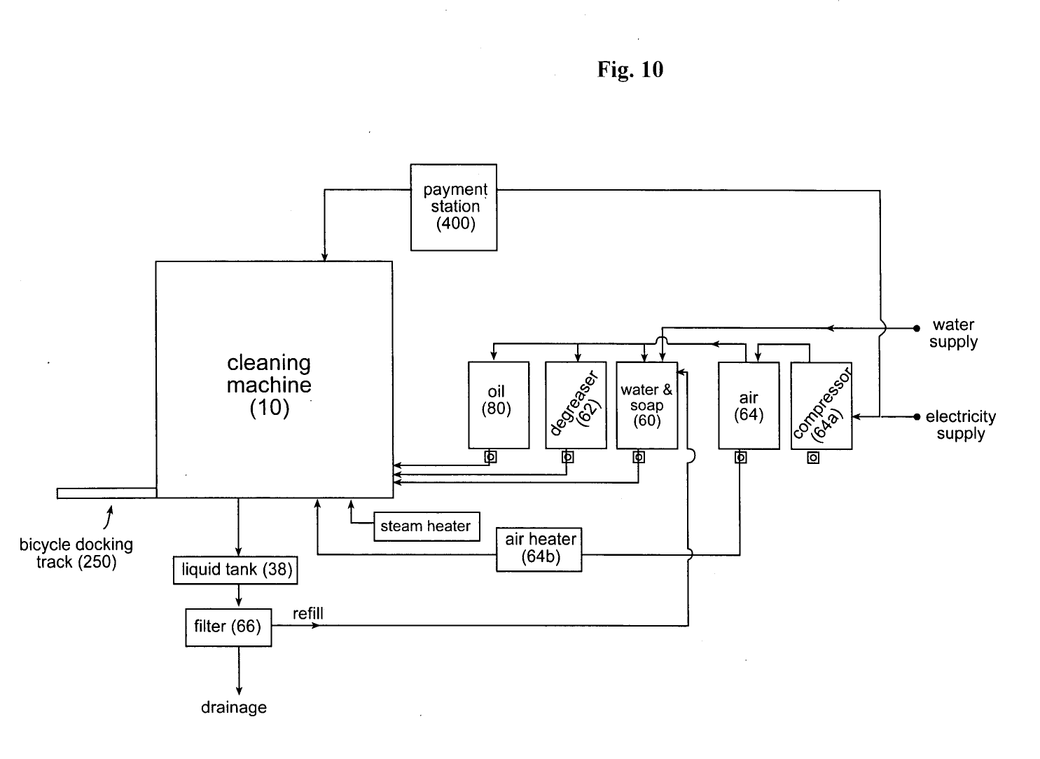

Reference is made to FIG. 10 showing a schematic view of the bicycle cleaning system. The cleaning machine (shell) 10 is controlled by a payment and activation unit 400. The cleaning machine (shell) 10 is alimented with supplies of oil, degreaser and cleaning product. An air compressor 64a compresses air which is then heated by an air heater 64b and can be released by the cleaning machine's 10 spray nozzles 29 as steam. fluid coming out of the cleaning machine 10 is collected in a fluid reservoir 38 and then either filtered using filter 66 and recycled or drained.

In accordance with the certain embodiments, the system is adapted to be stationary, and may therefore be built in to a structure; while in accordance with other embodiments, it is adapted to be portable, mutatis mutandis. In addition, the system can be adapted to clean vehicles of other configurations and types, for example, recombinant bicycles, which are often 3-wheeled bicycles, and so on.

### Operation:

Initially, the bicycle 100 needs to be positioned within the shell 10. This can be done in several ways, for example, by securing the bicycle 100 to a bicycle docking track 250 which then takes the bicycle 100 automatically within the shell 10. Alternatively, the bicycle 100 can be brought manually within the shell 10 and then be clamped to the support stand 14.

After positioning the bicycle 100 within the shell 10, the cleaning can commence. The cleaning can be activated, for example, by a dedicated operator; however, in accordance with particular embodiments, the system is activated upon payment to an automated payment and activation unit 400.

In a first step, the bicycle's 100 transmission system is activated as described above, for example, by spinning the rear wheel 108.

In a second step, degreaser from the degreasing solution source 62 is sprayed via some or all of the nozzles 29 onto the corresponding parts of the bicycle 100, for example, for about ten seconds. At this time, those brushes that rotate (brushes 24, 26, 27, 52 and in according to certain embodiments, brush 42) are rotated. The brushes (brushes 24, 26, 27, 52 76, 27a, 27b, 410, for gear transmission handle 350 and in according to certain embodiments, brush 42) approach the bicycle 100 either to a predetermined distance, or by using distance estimation sensors approach to the appropriate distance where the hairs can be in touch with the bicycle 100 to brush away and clean the dirt mechanically.

In a third step and after waiting for the degreaser product to make its effect, cleaning product from the cleaning product source 60 is sprayed via all of the nozzles 29 onto the corresponding parts of the bicycle, for example, for about ten seconds. At this time those brushes that rotate (brushes 24, 26, 27, 42 and 52) are rotated (or continue to rotate).

Although the aforementioned order of first degreasing and then spraying cleaning product is likely preferable, it should be understood that the order can be reversed.

Finally, the brush rotation is stopped and forced air from the pressurized air source 64 is blown via all of the nozzles 29 onto the corresponding parts of the bicycle 100 to dry them, for example, for about ten seconds.

Optionally, the system can dispense several maintenance products such as, lubrication on several points of the transmission system; tire maintenance product; and frame lubrication product. For example, any oil such as “JOE′S BICYCLE CHAIN LUBE” or “JOE'S BICYCLE FRAME AND TIRE SHINE” made by No-Flats Ltd. of Moshav Givat Hen, 43905 Raanana, Israel

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

1. A bicycle cleaning system, comprising:
(i) one or more spray nozzles wherein at least one spray nozzle is adapted to dispense a cleaning product; and
(ii) a mechanism for reaching all the components of the bicycle's transmission system such that they can be sprayed by said one or more spray nozzles.

2. A bicycle cleaning system according to claim 1, further comprising one or more brushes adapted to be in contact with all the components of the bicycle's transmission system.

3. A bicycle cleaning system according to claim 2, wherein one or more brushes are rotating brushes.

4. A bicycle cleaning system according to claim 1, wherein said mechanism for reaching all the components of the bicycle's transmission system spins the bicycle's rear wheel.

5. A bicycle cleaning system according to claim 1, wherein said mechanism for reaching all the components of the bicycle's transmission system spins the bicycle's rear wheel counter-clockwise.

6. A bicycle cleaning system according to claim 1, wherein one spray nozzle dispenses a degreaser product.

7. A bicycle cleaning system according to claim 1, adapted for lubrication of the bicycle's transmission system by first dispensing hot and dry air and then dispensing a lubricating product.

8. A bicycle cleaning system according to claim 1, wherein one spray nozzle dispenses hot vapor.

9. A bicycle cleaning system according to claim 1, wherein the cleaning product is a fluid.

10. A bicycle cleaning system according to claim 9, wherein said cleaning fluid comprises water and soap.

11. A bicycle cleaning system according to claim 1, wherein the cleaning product is a solid material.

12. A bicycle cleaning system according to claim 11, wherein said solid material is small nylon, rubber, or sponge corpuscles.

13. A method for cleaning a bicycle comprising the steps of:
(i) dispensing a cleaning product through at least one spray nozzle; and
(ii) applying a mechanism for reaching all the components of the bicycle's transmission system such that they can be sprayed by said one or more spray nozzles.

14. A method for cleaning a bicycle according to claim 13, further comprising the step of brushing the bicycle with one or more brushes such that said one or more brushes can be in contact with all the components of the bicycle's transmission system.

15. A method for cleaning a bicycle according to claim 14, wherein one or more brushes are rotating brushes.

16. A method for cleaning a bicycle according to claim 13, wherein said mechanism for reaching all the components of the bicycle's transmission system spins the bicycle's rear wheel.

17. A method for cleaning a bicycle according to claim 13, wherein said mechanism for reaching all the components of the bicycle's transmission system spins the bicycle's rear wheel counter-clockwise.

18. A method for cleaning a bicycle according to claim 13, wherein one spray nozzle dispenses a degreaser product.

19. A method for cleaning a bicycle according to claim 13, adapted for lubrication of the bicycle's transmission system by first dispensing hot and dry air and then dispensing a lubricating product.

20. A method for cleaning a bicycle according to claim 13, wherein one spray nozzle dispenses hot vapor.

21. A method for cleaning a bicycle according to claim 13, wherein the cleaning product is a fluid.

22. A method for cleaning a bicycle according to claim 21, wherein said cleaning fluid comprises water and soap.

23. A method for cleaning a bicycle according to claim 13, wherein the cleaning product is a solid material.

24. A method for cleaning a bicycle according to claim 23, wherein said solid material is small nylon, rubber, or sponge corpuscles.
